(19) United States
(12) Patent Application Publication
(10) Pub. No.: US 2008/0136351 A1
(43) Pub. Date: Jun. 12, 2008

(54) BACK LIGHT UNIT AND TRANSFORMER

(75) Inventors: Chi-Hsiu Lin, Yunlin County (TW); Po-Kun Hsieh, Taoyuan County (TW); Bi-Hsien Chen, Pingtung County (TW)

Correspondence Address: J C PATENTS, INC., 4 VENTURE, SUITE 250, IRVINE, CA, 92618, US

(73) Assignee: CHUNGHWA PICTURE TUBES, LTD., Taipei (TW)

(21) Appl. No.: 11/608,101

(22) Filed: Dec. 7, 2006

(51) Int. Cl. H05B 41/36; H01F 27/29

(52) U.S. Cl. 315/294; 336/192; 315/291

(57) ABSTRACT

A back light unit comprising a light source and a transformer is provided. The transformer has a first side and a second side. The first side is used to receive a pulse width modulation (PWM) signal. More specifically, the second side has a first terminal, a measurement terminal and a second terminal. The first terminal is grounded so that a first inductance is formed between the measurement terminal and the first terminal and a second inductance is formed between the second terminal and the first terminal. In addition, the measurement terminal outputs a measurement voltage to represent a work characteristic parameter and the second terminal outputs a driving signal to drive the light source.

### BACKGROUND OF THE INVENTION

1. Field of the Invention

The present invention relates to a back light unit, and more particularly, to a back light unit capable of measuring its loading state without using an external circuit.

2. Description of Related Art

Cold cathode fluorescent lamp (CCFL) is a type of low-pressure mercury discharge lamp. When the two ends of the CCFL is directly connected to a power source, the mercury and the gaseous atoms within the lamp bombard against each other to produce ultraviolet (UV) light. When the UV light impinges the wall of the lamp, the fluorescent substance on the wall converts the UV light into visible light. Because the CCFL does not need any lamp fuse, there is no burnt-out or broken fuse problem. Hence, the CCFL is extremely reliable and has a long life.

When the CCFL is in stable operation, it is powered by a sine wave without any DC components and the required power frequency is between about 30 KHz˜80 KHz. The stable operating voltage of the lamp approaches a constant value and the current passing through the lamp determines the brightness level of the lamp. To start-up the lamp, a voltage of about 2˜2.5 times that of the stable operating voltage is applied. The start-up voltage and the operating voltage of the CCFL are largely based on the dimension of the lamp. For the CCFL of a 14 or 15 inch liquid crystal display, the start-up voltage is around 1400 Vrms, the maximum permissible current is about 7 mA and the operating voltage is around 650 Vrms.

Because CCFL has the special characteristic of a negative resistance, the resistance will slowly reduce after operating for a period of time leading to a gradual increase in the corresponding current. Hence, if a feedback mechanism is not properly set up, the brightness of the CCFL may be unstable and fluctuate from time to time.

FIG. 1 is a circuit diagram of a conventional back light unit. As shown in FIG. 1, the conventional back light unit 100 includes a pulse width modulation (PWM) unit 102 for generating PWM signals to drive the cold cathode fluorescent lamp (CCFL) 104. The output of the PWM unit is input to a first side 108 of the transformer 106. Then, the second side 110 of the transformer 106 senses the input of the first side 108 and generates a driving signal Id to drive the CCFL 104.

To ensure a stable operation of the CCFL 104, external circuits 112, 114 and 116 are disposed on the second side 110 of the transformer 106 for measuring the operating voltage and operating current of the CCFL 104. These measurements are used as a base for adjusting the duty cycle of the PWM signal from the PWM unit. The structure and function of each external circuit are explained below:

1. The external circuit 112 includes a first capacitor C1 and a second capacitor C2 serially connected together and disposed between the two output terminals 110a and 110b on the second side 110 of the transformer 106 to serve as a voltage divider. Thus, the user can measure a voltage feedback signal Vf through a contact between the first capacitor C1 and the second capacitor C2. This voltage feedback signal Vf can be used to determine whether or not the CCFL 104 is lit and can be used as a base for over-voltage protection.

2. The external circuit 114 includes a resistor RI for connecting the output terminal 110b on the second side 110 to a ground. Hence, the user can detect whether the CCFL 104 has a short circuit or an open circuit according to the current Ia flowing through the resistor RI. When the CCFL 104 is in normal operation, the current Ia should have a stable value.

3. The external circuit 116 includes another resistor R2 for connecting one end of the CCFL 104 to a ground. Thus, the user can detect whether the CCFL 104 has a short circuit or an open circuit according to the current Ib flowing through the resistor R2. When the CCFL 104 is in normal operation, the current Ib should have a stable value.

Although the conventional back light unit can effectively maintain a stable operation of the CCFL, the additional external circuits increase the hardware cost. In particular, the capacitor C1, for example, needs to have a large capacitance to match the start-up voltage of a CCFL of more than 1 KV so that the overall hardware cost is increased.

### SUMMARY OF THE INVENTION

Accordingly, at least one objective of the present invention is to provide a transformer suitable for a back light unit that can provide a cold cathode fluorescent lamp (CCFL) with a variety of work characteristic parameters for normal operation.

At least another objective of the present invention is to provide a back light unit that can measure the operating voltage and current of a cold cathode fluorescent lamp (CCFL) without any external circuits.

To achieve these and other advantages and in accordance with the purpose of the invention, as embodied and broadly described herein, the invention provides a transformer. The transformer has a first side and a second side. More specifically, the second side has a first terminal, a measurement terminal and a second terminal. A first inductance is formed between the measurement terminal and the first terminal. In addition, a second inductance is formed between the second terminal and the first terminal.

From another perspective, the present invention also provide a back light unit including a light source and a transformer. The transformer has a first side and a second side. The first side is used to receive a pulse width modulation (PWM) signal. More specifically, the second side has a first terminal, a measurement terminal and a second terminal. The first terminal is grounded. A first inductance is formed between the measurement terminal and the first terminal and a second inductance is formed between the second terminal and the first terminal. Furthermore, a measurement voltage can be measured from the measurement terminal. The measurement voltage represents one of the work characteristic parameters of the light source. The second terminal outputs a driving signal to drive the light lighting.

From another perspective, the present invention provides an alternative back light unit including a plurality of light sources and a transformer. The transformer has a first side and a plurality of second sides. The first side is used to receive a pulse width modulation (PWM) signal and each of the second sides is electrically connected to one of the corresponding light sources. More specifically, each of the second sides has a first terminal, a measurement terminal and a second terminal. The first terminal is grounded. A first inductance is formed between the measurement terminal and the first terminal and a second inductance is formed between the second terminal and the first terminal. Furthermore, a measurement voltage can be measured from the measurement terminal. The measurement voltage represents one of the work characteristic parameters of the light source. The second terminal outputs a driving signal to drive the corresponding light lighting.

From another perspective, the present invention also provides another type of transformer similarly having a first side and a second side. More specifically, the second side of the transformer has a first terminal, a second terminal and a plurality of measurement terminals. The inductance between each of the measurement terminals and the second terminal and the first terminal are different.

From another perspective, the present invention also provides an alternative back light unit including a light source and a transformer. The transformer has a first side and a second side. The first side is used to receive a pulse width modulation (PWM) signal. More specifically, the second side has a first terminal, a second terminal and a plurality of measurement terminals. The first terminal is grounded. The inductance between each of the measurement terminals and the second terminal and the first terminal are different. Furthermore, a different measurement voltage can be measured from each of the measurement terminals. The measurement voltages represent different work characteristic parameters of the light source. The second terminal outputs a driving signal to drive the corresponding light lighting.

The present invention also provides a back light unit including a plurality of light sources and a transformer. The transformer has a first side and a plurality of second sides. The first side is used to receive a pulse width modulation (PWM) signal. Each of the second sides is electrically connected to one of the corresponding light sources. More specifically, each of the second sides has a first terminal, a second terminal and a plurality of measurement terminals. The first terminal is grounded. The inductance between each of the measurement terminals and the second terminal and the first terminal are different. Furthermore, a different measurement voltage can be measured from each of the measurement terminals of each of the second sides. The measurement voltages represent different work characteristic parameters of the corresponding light sources. The second terminal of each of the second sides outputs a driving signal to drive the corresponding light lighting.

Accordingly, the transformer in the present invention has one to a few measurement terminals capable of measuring different measurement voltages. Through these measurement voltages, a user is able to obtain various work characteristic parameters of the light without disposing other external circuits.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a circuit diagram of a conventional back light unit.

FIG. 2 is a circuit diagram of a back light unit according to a first embodiment of the present invention.

FIG. 3 is a circuit diagram of a back light unit according to a second embodiment of the present invention.

FIG. 4 is a circuit diagram of a back light unit according to a third embodiment of the present invention.

FIG. 5 is a circuit diagram of a back light unit according to a fourth embodiment of the present invention.

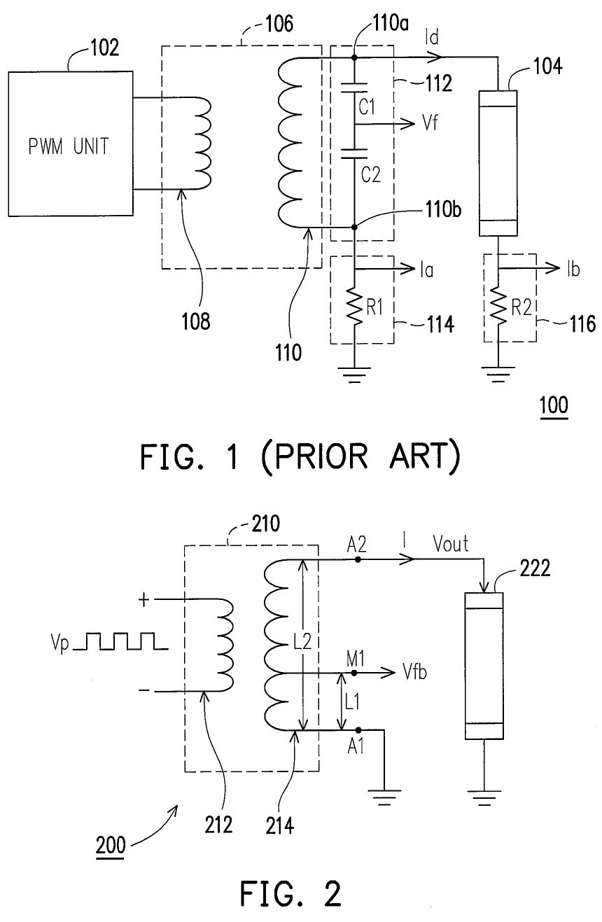

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In the following, a few preferred embodiments are used to illustrate the characteristics of the present invention. The present invention is suitable for using cold cathode fluorescent lamp (CCFL) as the light source of the back light unit. In the following description, CCFL is used as an example. However, anyone familiar with the knowledge in this area should know that the present invention also covers other types of light sources and this particular point does not have to be repeatedly stressed in the following description.

Furthermore, the pulse width modulation (PWM) signal mentioned in the following description can be generated by a pulse width modulation (PWM) unit. Again the generation of the PWM signal by the PWM unit will not be repeatedly mentioned in the following description.

### First Embodiment

FIG. 2 is a circuit diagram of a back light unit according to a first embodiment of the present invention. As shown in FIG. 2, the back light unit 200 in the present invention includes a transformer 210 that drives a cold cathode fluorescent lamp (CCFL) 222 to light up according to a PWM signal Vp.

The transformer 210 has a first side 212 and a second side 214. The first side 212 receives the PWM signal Vp. More specifically, the second side 214 has a first terminal A1, a second terminal A2 and a measurement terminal M1. In the present embodiment, the first terminal A1 is grounded. An inductance L1 is formed between the first terminal A1 and the measurement terminal M1 and another inductance L2 is formed between the first terminal A1 and the second terminal A2. In the present embodiment, the second terminal A2 is electrically connected to the CCFL 222. Hence, the transformer 210 can output a driving signal I to drive the CCFL 222 according to the PWM signal Vp. On the other hand, a measurement voltage Vfb can be measured through the measurement terminal M1.

Because the measurement terminal, the first terminal A1 and the second terminal A2 are disposed within the same magnetic circuit, their relation can be described using:

λ=L•I (1),

where

λ: the induced flux, and its relation with voltage is V=dλ/dt,

L: the inductance on the second side of the transformer 210.

According to formula (1), V and I have a linear relation. Therefore, when the back light unit 200 is in operation, the relations between the output voltage Vout on the second side of the transformer 210 and the measurement voltage Vfb are:

$$\begin{matrix}Vout = \frac{d λ 2}{d t} = \frac{d}{d t} ( L 2 \cdot I ) , & ( 2 ) \\ Vfb = \frac{d λ 1}{d t} = \frac{d}{d t} ( L 1 \cdot I ) . & ( 3 )\end{matrix}$$

According to the two foregoing formulae:

$$Vout \text{:} Vfb = L 2 \text{:} L 1 \\ Vfb = \frac{L 1}{L 2} Vout \qquad ( 4 )$$

According to formula (4), a user is able to determine whether the voltage or current at the output terminal (the second terminal) A2 of the transformer actually meets the voltage or current required by the CCFL 222 through the measurement voltage Vfb. Hence, whether or not the back light unit 200 operates normally can be easily assessed.

### Second Embodiment

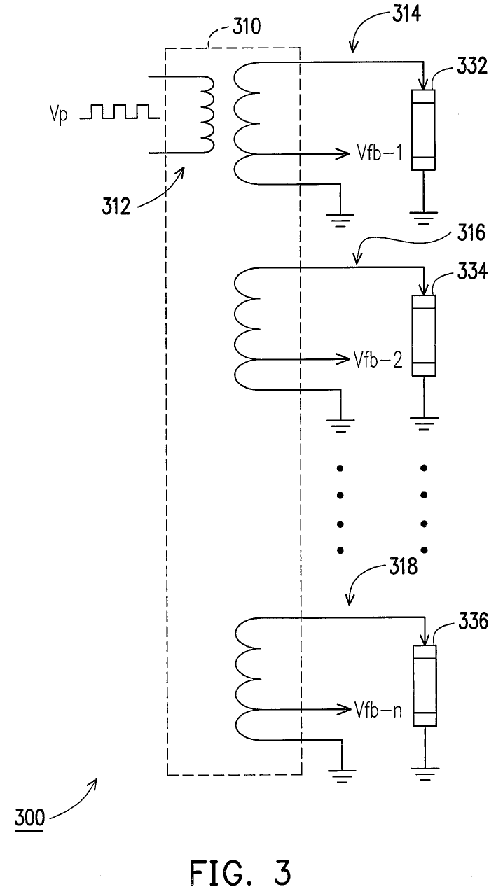

FIG. 3 is a circuit diagram of a back light unit according to a second embodiment of the present invention. As shown in FIG. 3, the back light unit 300 in the present embodiment has a plurality of cold cathode fluorescent lamps (CCFL), for example, 332, 334, . . . , 336. Therefore, the transformer of the back light unit 300 has a first side 312 but a plurality of second sides 314, 316, . . . , 318.

The first side 312 of the transformer receives the PWM signal Vp and each of the second sides 314, 316, . . . , 318 is electrically connected to one of the corresponding cold cathode fluorescent lamps. Thus, the transformer 310 is able to drive the cold cathode fluorescent lamps 332, 334, . . . , 336 according to the PWM signal Vp. In the present embodiment, each of the second sides 314, 316, . . . , 318 has a structure identical to that of the second side 214 in the first embodiment. Since anyone having knowledge in this area may deduce the overall layout of this structure, a detailed description is omitted.

Because each of the second sides 314, 316, . . . , 318 has a structure identical to that of the second side 214 in the first embodiment, the user may obtain the work characteristic parameters such as operating voltage or operating current of each cold cathode fluorescent lamp through the measurement voltages Vfb-1, Vfb-2, . . . , Vfb-n.

### Third Embodiment

Sometimes, the user needs to simultaneously measure the different work characteristic parameters of a cold cathode fluorescent lamp. In the third embodiment of the present invention, another back light unit is provided.

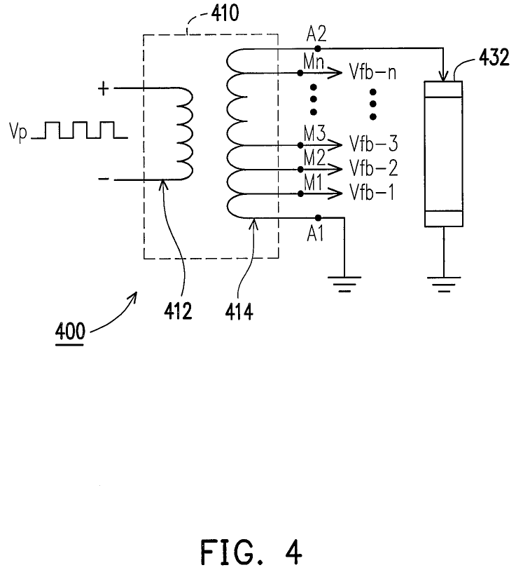

FIG. 4 is a circuit diagram of a back light unit according to a third embodiment of the present invention. As shown in FIG. 4, the back light unit 400 similarly includes a transformer 410 having a first side 412 and a second side 414. The first side 412 is used to receive a pulse width modulation (PWM) signal Vp. More specifically, the second side 414 of the transformer 410 has a first terminal Al, a second terminal A2 and a plurality of measurement terminals M1, M2, M3, . . . , Mn.

In the present embodiment, the first terminal A1 is grounded and the second terminal A2 is electrically connected to the cold cathode fluorescent lamp (CCFL) 432. Furthermore, each of the measurement terminals M1, M2, M3, . . . , Mn is able to measure a different voltage Vfb-1, Vbf-2, Vfb-3, . . . , Vfb-n, respectively. Moreover, a different inductance is formed between the first terminal A1 and each of the measurement terminals M1, M2, M3, . . . , Mn and between the first terminal A1 and the second terminal A2. Thus, the user can simultaneously obtain the different work characteristic parameters of the cold cathode fluorescent lamp 432 through the different voltages Vfb-1, Vfb-2, Vfb-3, . . . , Vfb-n. Refer to the first embodiment because a detailed description of the theory has already been described.

### Fourth embodiment

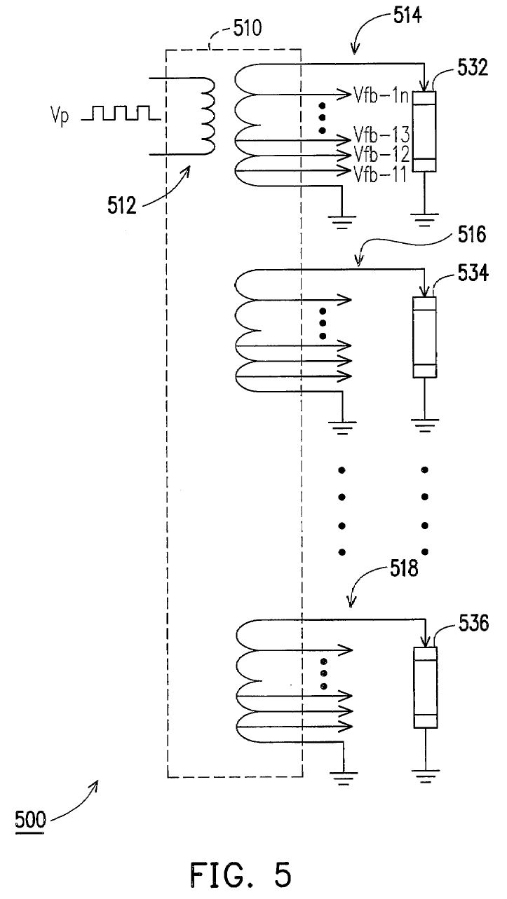

FIG. 5 is a circuit diagram of a back light unit according to a fourth embodiment of the present invention. As shown in FIG. 5, the back light unit 500 having a plurality of cold cathode fluorescent lamps 532, 534, . . . , 536 is similar to the back light unit 300 in the second embodiment. Furthermore, the back light unit 500 similarly has a transformer 510 having a first side 512 and a plurality of second sides 514, 516, . . . , 518. The first side 512 is used to receive a pulse width modulation (PWM) signal Vp. Each of the second sides 514, 516, . . . , 518 is electrically connected to one of the corresponding cold cathode fluorescent lamps 532, 534, . . . , 536.

The main difference of the back light unit 500 from the back light unit 300 is that the structure of each of the second sides 514, 516, . . . , 518 in the back light unit 500 is identical to the structure of the second side 414 in the third embodiment. Thus, the user is able to obtain the work characteristic parameters corresponding to the cold cathode fluorescent lamp through the voltage measured on each of the second sides. For example, the user may obtain the work characteristic parameters such as the operating voltage or the operating current of the cold cathode fluorescent lamp 532 according to the voltages Vfb-11, Vfb-12, Vfb-13, . . . , Vfb-1n generated on the second side 514.

In summary, forming a measurement terminal on the second side in the present invention only requires an additional procedure in winding the second side, which is technically easy to achieve. Therefore, a variety of work characteristic parameters of the light source can be measured without spending too much on special hardware.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A transformer suitable for driving a back light unit, having a first side and a second side, wherein the second side comprises a first terminal; a measurement terminal, forming a first inductance with the first terminal; and a second terminal, forming a second inductance with the first terminal.

2. A back light unit, comprising:
a light source; and
a transformer, having a first side and a second side, wherein the first side receives a pulse width modulation signal, and the second side has a first terminal, a measurement terminal and a second terminal such that the first terminal is grounded, a first inductance is formed between the measurement terminal and the first terminal and a second inductance is formed between the second terminal and the first terminal,
wherein a voltage measured at the measurement terminal represents a work characteristic parameter of the light source, and the second terminal outputs a driving signal for driving the light source.

3. The back light unit of claim 2, further comprising a pulse width modulation unit for generating the pulse width modulation signal.

4. The back light unit of claim 2, wherein the light source is a cold cathode fluorescent lamp.

5. The back light unit of claim 4, wherein one end of the cold cathode fluorescent lamp is electrically connected to the second terminal of the second side and another end of the cold cathode fluorescent lamp is grounded.

6. The back light unit of claim 2, wherein the work characteristic parameter is either an operating voltage or an operating current of the light source.

7. A back light unit, comprising:
a plurality of light sources; and
a transformer, having a first side and a plurality of second sides, wherein the first side receives a pulse width modulation signal and each of the second sides is electrically connected to one of the light sources respectively, and furthermore, each of the second sides has a first terminal, a measurement terminal and a second terminal such that the first terminal is grounded, a first inductance is formed between the measurement terminal and the first terminal and a second inductance is formed between the second terminal and the first terminal,
wherein a voltage measured at each measurement terminal represents a work characteristic parameter of the corresponding light source, and each second terminal outputs a driving signal to drive the corresponding light source.

8. The back light unit of claim 7, further comprising a pulse width modulation unit for generating the pulse width modulation signal.

9. The back light unit of claim 7, wherein the light sources are cold cathode fluorescent lamps.

10. The back light unit of claim 9, wherein one end of each cold cathode fluorescent lamp is electrically connected to the corresponding second terminal on the second side and the other end of the cold cathode fluorescent lamp is grounded.

11. The back light unit of claim 7, wherein the work characteristic parameter of each light source is either an operating voltage or an operating current of the light source.

12. A transformer suitable for driving a back light unit, having a first side and a second side, wherein the second side comprises a first terminal, a second terminal and a plurality of measurement terminals, and the inductances between each of measure terminals and the first terminal and between the second terminal and the first terminal are different.

13. A back light unit, comprising:
a light source, and
a transformer, having a first side and a second side, wherein the first side receives a pulse width modulation signal and the second side has a firs terminal, a second terminal and a plurality of measurement terminals such that the first terminal is grounded, and the inductances between each of measurement terminals and the first terminal and between the second terminal and the first terminal are different,
wherein a different voltage measured at each measurement terminal represents a different work characteristic parameter of the light source, and the second terminal outputs a driving signal for driving the light source.

14. The back light unit of claim 13, further comprising a pulse width modulation unit for generating a pulse width modulation signal.

15. The back light unit of claim 13, wherein the light source is a cold cathode fluorescent lamp.

16. The back light unit of claim 15, wherein one end of the cold cathode fluorescent lamp is electrically connected to the second terminal of the second side and the other end of the cold cathode fluorescent lamp is grounded.

17. The back light unit of claim 15, wherein the work characteristic parameter of the light source is either an operating voltage or an operating current of the light source.

18. A back light unit, comprising:
a plurality of light sources; and
a transformer, having a first side and a plurality of second sides, wherein the first side receives a pulse width modulation signal and each second side is electrically connected to one of the corresponding light sources respectively, and each second side has a first terminal, a second terminal and a plurality of measurement terminals such that the first terminal is grounded and the inductances between each of measure terminals and the first terminal and between the second terminal and the first terminal are different,
wherein a different voltage at each measurement terminal of each second side represents a different work characteristic parameters of the corresponding light source, and the second terminal of each second side outputs a driving signal to drive the corresponding light source.

19. The back light unit of claim 18, further comprising a pulse width modulation unit for generating the pulse width modulation signal.

20. The back light unit of claim 18, wherein the light sources are cold cathode fluorescent lamps.

21. The back light unit of claim 20, wherein one end of the cold cathode fluorescent lamps are electrically connected to the corresponding second terminals of the second side and the other end of the cold cathode fluorescent lamps are grounded.

22. The back light unit of claim 18, wherein the work characteristic parameter of each light source is either an operating voltage or an operating current of the light source.
